(19) United States
(12) Patent Application Publication
(10) Pub. No.: US 2009/0265354 A1
(43) Pub. Date: Oct. 22, 2009

(54) METHOD FOR ELECTRONIC DATABASE MANIPULATION

(76) Inventors: Joseph Machak, Ann Arbor, MI (US); Rodney Machak, Dearborn, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/426,533

(22) Filed: Apr. 20, 2009

Related U.S. Application Data
(60) Provisional application No. 61/046,059, filed on Apr. 18, 2008.

(51) Int. Cl. G06F 17/30; G06F 17/21

(52) U.S. Cl. 707/9; 707/10; 715/221; 707/E17.005; 707/E17.032

(57) ABSTRACT

A method and system for remotely modifying a database uses an electronic form stored on a remote computer. The electronic form is filled out by a user and submitted to the database. Once the database determines that the user is authorized, the database is updated to match the information contained in the form.

### REFERENCES TO RELATED APPLICATIONS

The application claims priority to U.S. Provisional Application No. 61/046,059 which was filed on Apr. 18, 2008.

### BACKGROUND OF THE INVENTION

In the materials industry, as well as in similar industries, a company often has an inventory containing several varying products. Each product has different characteristics and will therefore only be suited for certain jobs. Products are typically grouped into groupings of like products which are referred to as “lots.” Typically, in the materials industry, product orders are taken at a central office which is located away from the warehouse which contains the actual products. Additionally, in such a business, a database server is typically housed in the warehouse and contains all the information about the physical lots in a database. Information related to each product is stored in the database and can be accessed locally at a warehouse or remotely at an office via a direct connection, or the Internet. Typical information which is stored could be reservation status of a lot, physical properties of the lot, amount of product in a given lot, price of the materials in a given lot, or shipping information for a lot. When an order is taken at the central office, it is necessary to interface with the database server, which is housed at the warehouse, and modify the product entries associated with the order.

In order to facilitate this, the electronic database can be remotely interfaced with, and the information contained in the electronic database can be edited as new shipments arrive, products are sold or used, or information regarding the lots changes. Directly connecting to large remote databases in this manner can be slow due to the volume of information which must be processed. This is especially true when taking orders in a central office and then modifying the remote database in the warehouse. Current systems interfacing with the remote database have a user log in, and then the system modifies the database entry as the user makes changes. This results in significant downtime, as a user must wait for the database to finish updating after each change before he can enter more information or modifications to the product entry.

### SUMMARY OF THE INVENTION

A system and method for modifying a product database allows a user to log into a database and submit an electronic form which has proposed database modifications. The electronic form contains all of the proposed modifications, and thereby circumvents the downtime associated with previous systems of database modification. The database server checks to ensure that the user has adequate permission to make the modifications and then makes the modifications according to the information provided on the electronic from.

These and other features of the present invention can be best understood from the following specification and drawings, the following of which is a brief description.

### DESCRIPTION OF THE DRAWINGS

The disclosure can be further understood by reference to the following detailed description when considered in connection with the accompanying drawings wherein:

FIG. 1 is a flowchart illustrating one example method for database manipulation.

FIG. 2 is an example form which could be used in conjunction with the method illustrated in FIG. 1.

FIG. 3 is an example system which can perform the example method of FIG. 1.

### DETAILED DESCRIPTION OF THE INVENTION

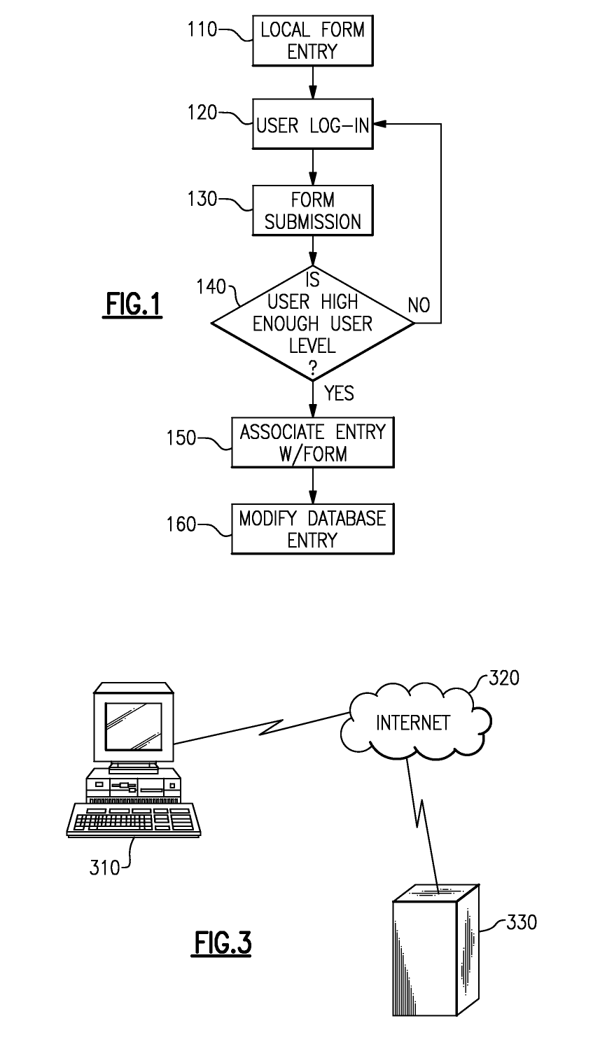

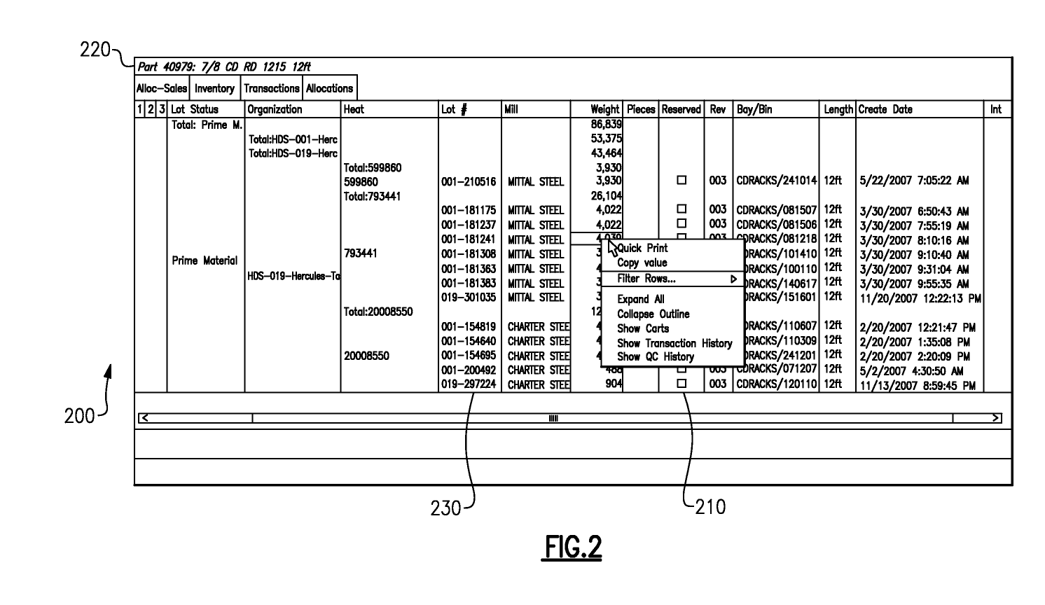

FIG. 1 illustrates an example flowchart of a database modification method. In a local form entry step 110, a user enters information into a locally stored electronic form 200 (see FIG. 2). Once the user has finished entering data into the electronic form 200, and the electronic form 200 has performed any calculations required, the electronic form 200 can be transmitted to a remote database server 330 (show in FIG. 3) hosting the database. In order to submit the electronic form 200, the user must first log into the remote database server 330 in a user log-in step 120.

In the user log-in step 120, the user accesses the remote database server 330 from a desktop computer 310, or any other connected computing device, via a username and password log-in. When the user submits his username and password, the remote database server 330 compares the username and password to a list of allowed usernames and passwords and allows access if the submission matches an entry on the allowed list. The remote database server 330 also assigns a user level to the user when he is logging in based on the username. The log-in step 120 and the local form entry step 110 could, alternately, switch positions in the method without affecting the performance of the method.

Once the first and second steps 110, 120 are completed, the user submits the electronic form 200 to the remote database server 330 in a form submission step 130. In the form submission step 130, the electronic form 200 is submitted as a whole to the remote database server 330. Since the electronic form 200 contains all the desired modifications to the database, long load times associated with changing each data entry are prevented as the user does not have to wait for each change to be implemented before entering a second change. Additionally, the user does not have to wait for the remote database server 330 to determine the appropriate product entry before making the changes. In this way after the user has submitted the electronic form 200 he may proceed to a different task, thereby saving time.

After the remote database server 330 has received the submission in the form submission step 130, a comparison step 140 is performed. In the comparison step 140, the remote database server 330 checks the username and user level against the desired database changes based on the submitted electronic form 200. If the electronic form 200 only requires changes which are equal to or lower than the user's user level, the remote database server 330 allows the process to move into an association step 150. If the user level of the user is not high enough, the database can provide an error prompt and returns to the user-log in step 120, and the modifications from the electronic form 200 are not entered.

In the association step 150, the remote database server 330 associates a specific database entry with the submitted electronic form 200. This can be done, for example, by comparing information on the electronic form 200 with each applicable product entry in the database. The electronic form 200 can identify the specific product to be associated with by either using a code which directly links the electronic form 200 to a product or by using identifying features. If the electronic form 200 uses identifying features, then the remote database server 330 will query the database for all entries which match the identifying features and associate one or more of the returned database entries with the electronic form 200.

Once the electronic form 200 has been associated with a database entry, a modify database entry step 160 is performed. In this step, the database entry is modified to coincide with the new information on the electronic form 200. The modifications can include adding a reservation status to the product entry, modifying a quantity available of the product entry, or any other relevant modifications.

In the above described method, the local electronic form 200 could be initially retrieved from remote database server 330 and then stored on the computer 310, or it could be stored in a set of standard forms pre-installed on the computer 310. The local form is an electronic form 200 which can be completed by a user and which could be stored locally on the computer 310. An example electronic form 200 is illustrated in FIG. 2. The electronic form 200 can also include fields which are completed automatically based on data which is entered by the user. For example, if the user has entered a “quantity” field and a “price per unit” field, the electronic form 200 can automatically calculate a total price field.

Prior to submission, the electronic form 200 is stored on the computer 310 and does not rely on communications with a remote database server 330 for completion. As a result of the electronic form 200 being stored on the computer 310 and the user entering all desired modifications before submitting the electronic form 200, the user does not see any of the time delay associated with looking up product entries in a large database. The electronic form 200 of FIG. 2 is hosted on the computer 310 and has at least a field 210 for placing a reservation status on a specific product. The illustrated electronic form 200 additionally has a product identification field 220 for entering identifying product information, such as a product number. Alternately, any other identifying information could be provided which would identify the specific product being reserved.

In a first example of the above described method, the electronic form 200 is used to place a soft reservation status on a specified product. An example electronic form 200 which would be used for reserving a product is illustrated in FIG. 2. The local electronic form 200 can incorporate any relevant information for a given job, including a soft reservation of products, or physical product requirements. The database, which the electronic form 200 will modify, can include any number of fields containing data relevant to a specific product, including fields which are not included on the electronic form 200. The example electronic form 200 of FIG. 2 is a product reservation form. The product reservation form can have fields 210, 220, 230 for inventory, specifications, accounts, demands, prices, costs, types, sizes, while the product database may have significantly more information regarding each product entry, such as routing, invoices, reservation status, etc.

If the electronic form 200 relates to a soft reservation of a product, then the electronic database can associate a physical product with the requirements of the electronic form 200 and update a “soft reservation” field 210 within the database to indicate the physical product is reserved. The soft reservation status may later be changed by a user having a sufficient user level using the same process. Alternately, if the electronic form 200 relates to physical product requirements for a given job, then the database can also accept the requirements and find a current lot in inventory that is acceptable or store the information for use at a later time.

In this example, after the remote database server 330 receives the electronic form 200, it associates a soft reservation to the desired product and updates a reservation status field within the database. After the update, the reservation status field indicates that the product has been reserved with a soft reservation. The soft reserve status can then be altered by a user with an adequately high user level.

A second example feature is also illustrated in FIG. 2. In the second example feature of the above described method, the user accesses the electronic form 200 and the remote database server 330 as described above. In this example, the electronic form 200 associates the data in at least a first field (for example the part identification field 220) of the electronic form 200 with at least a second field (for example, a lot number field 230.) The type of association may vary depending on the specific application. When the user enters a value, such as a product identifier, into the first field 220 (and into any other fields associated with the second field 230), the data, such as the lot number, for the second field 230 is automatically determined by the electronic form 200 based on the manually entered variables from the first field 220 and any other associated fields. The user may then choose to accept the determined data, or the user may manually adjust the data within the second field 230. It is anticipated that the same embodiment could associate more than one field with a single data entry, or associate a single field with multiple data entries. Once the user has completed entering his data and has reviewed the data that was determined by the electronic form 200, the information is sent to the electronic database, using the above described method.

An example system capable of implementing the above described method is illustrated in FIG. 3. The example of FIG. 3 has the computer 310 (such as the user's computer) which is connected to the Internet 320. Additionally connected to the Internet 320 is the database server 330. Alternately, a private network could be utilized in place of the Internet and achieve the same results. In the system, the local electronic form 200 is originally stored on the user computer 310. The user can then log into the database server 330 through the Internet 320 using the user log-in step 120, described above. Once the user has logged in, the process proceeds as described above.

Although one embodiment of this invention has been disclosed, a worker of ordinary skill in this art would recognize that certain modifications would come within the scope of this invention. For that reason, the following claims should be studied to determine the true scope and content of this invention.

What is claimed is:

1. A method for modifying a product database comprising the steps of:
allowing a user to log into a database server using a username;
accepting an electronic form containing proposed database modifications;
determining if said user has permission to make said database modifications;
associating modifications in said electronic form with a product entry in said database; and
updating said database to match modifications contained on said electronic form when said step of determining if determines that said user has permission to make said database modifications.

2. The method of claim 1, wherein said step of determining if said user has permission to make said database modifications comprises the steps of:
determining a required user access level required for said modifications;
determining an access level of said user based on said username;
comparing said access level with said required user access level; and
allowing said modifications to continue when said access level is equal to or greater than said required user access level.

3. The method of claim 1, wherein said step of associating modifications in said electronic form with a product entry in said product database comprises identifying a group of products and associating each product in said group with said electronic form.

4. The method of claim 1, wherein said step of associating modifications in said electronic form with a product entry in said product database comprises identifying a specific product entry corresponding to a physical product and associating said specific product entry with said electronic form.

5. The method of claim 1, wherein said electronic form comprises at least one self calculating field, and an entry for said self calculating field is computed by said electronic form based on information entered into at least one other field.

6. The method of claim 1, wherein said step of updating said database to match said modifications contained on said electronic form comprises at least marking a product entry with a soft-reservation status.

7. The method of claim 6, wherein said step of updating said product database to match modifications contained on said electronic form additionally comprises flagging said product entry such that the soft-reservation status may be updated by a user at a later date.

8. The method of claim 6, comprising the step of reserving a physical product corresponding to said product entry until said soft-reservation status is modified.

9. The method of claim 1, wherein a computer readable medium stores instructions for performing the steps of the method.

10. The method of claim 2, wherein a computer readable medium stores instructions for performing the steps of the method.

11. A system for remote database manipulation comprising:
a local user computer connected to a network and containing instructions for a creating and modifying an electronic form;
a database server connected to the network including a computer readable medium for storing instructions for allowing a user to log into the database server using a username, accepting an electronic form containing proposed database modifications, determining if said user has permission to make said database modifications, associating a product entry in said database with said electronic form, and updating said database to match modifications contained on said electronic form.
